(19) United States
(12) Patent Application Publication
(10) Pub. No.: US 2026/0084117 A1
(43) Pub. Date: Mar. 26, 2026

(54) Gas Separation Membrane And Method For Producing Gas Separation Membrane

(71) Applicant: SEIKO EPSON CORPORATION, Tokyo (JP)

(72) Inventor: Takeo KOIKE, Chino (JP)

(21) Appl. No.: 19/339,866

(22) Filed: Sep. 25, 2025

(30) Foreign Application Priority Data
Sep. 26, 2024 (JP) 2024-167328

(51) Int. Cl. B01D 69/12; B01D 67/00; B01D 71/52; B01D 71/70

(52) U.S. Cl. CPC B01D 69/1214; B01D 67/0006; B01D 71/5211; B01D 71/70; B01D 2257/504; B01D 2323/12

(57) ABSTRACT

A gas separation membrane for permeating and separating carbon dioxide from a mixed gas containing the carbon dioxide includes: a sheet-shaped support layer; and a separation layer provided on one surface of the support layer, the separation layer having a function of selecting and separating carbon dioxide and being formed of a polymer containing a polyethylene oxide structural unit and a polysiloxane structural unit. The separation layer has an average thickness of 1 nm or more and 500 nm or less. When an XPS spectrum of the separation layer is obtained by X-ray photoelectron spectroscopy and a Si2p peak and a C1s peak included in the XPS spectrum are each subjected to waveform separation, an intensity ratio P(Si—O)/P(C—O) of a Si—O peak intensity P(Si—O) to a C—O peak intensity P(C—O) is 0.03 or more and 2.0 or less.

The present application is based on, and claims priority from JP Application Serial Number 2024-167328, filed Sep. 26, 2024, the disclosure of which is hereby incorporated by reference herein in its entirety.

### BACKGROUND

### 1. Technical Field

The present disclosure relates to a gas separation membrane and a method for producing a gas separation membrane.

### 2. Related Art

In order to implement carbon neutrality or carbon minus, a technique is being considered to absorb and collect carbon dioxide discharged from thermal power plants, boiler facilities, or the like, and carbon dioxide in the atmosphere. As that technique, there has been known a membrane separation method of separating carbon dioxide using a gas separation membrane.

For example, JP-A-2015-160159 discloses a gas separation membrane including a porous support, a polymer layer provided on the porous support, and a gel layer provided on the polymer layer. In the gas separation membrane, the polymer layer contains a polydimethylsiloxane, and the gel layer contains a cross-linked polymer having a polyethylene glycol skeleton and a liquid such as polyethylene glycol. According to such a configuration, the gel layer has high gas permeability and high gas selectivity, while the polymer layer can prevent an occurrence of defects when the gel layer is made thin, so that the gel layer can be made thin and the performance of the gel layer can be utilized.

JP-A-2015-160159 is an example of the related art.

On the other hand, a polydimethylsiloxane has low gas selectivity for carbon dioxide, and a cross-linked polymer having a polyethylene glycol skeleton has low gas permeability for carbon dioxide and low mechanical strength.

Therefore, an object is to implement a gas separation membrane having high gas selectivity and high gas permeability for carbon dioxide and excellent mechanical strength.

### SUMMARY

A gas separation membrane according to an application example of the present disclosure is a gas separation membrane for permeating and separating carbon dioxide from a mixed gas containing the carbon dioxide. The gas separation membrane includes: a sheet-shaped support layer; and a separation layer provided on one surface of the support layer, the separation layer having a function of selecting and separating carbon dioxide and being formed of a polymer containing a polyethylene oxide structural unit and a polysiloxane structural unit. The separation layer has an average thickness of 1 nm or more and 500 nm or less. When an XPS spectrum of the separation layer is obtained by X-ray photoelectron spectroscopy and a Si2p peak and a C1s peak included in the XPS spectrum are each subjected to waveform separation, an intensity ratio P(Si—O)/P(C—O) of a Si—O peak intensity P(Si—O) to a C—O peak intensity P(C—O) is 0.03 or more and 2.0 or less.

A method for producing a gas separation membrane according to an application example of the present disclosure is a method for producing the gas separation membrane according to the application example of the present disclosure. The method includes: mixing a polyethylene glycol compound having a first reactive functional group at an end of a main chain and a polysiloxane compound having a second reactive functional group at an end of a main chain, the second reactive functional group being reactive with and bondable to the first reactive functional group, to obtain a mixture; heating the mixture to react the first reactive functional group with the second reactive functional group to obtain a reactant; applying the reactant to one surface of the support layer to form a coating film; and applying energy to the coating film to form the separation layer.

### BRIEF DESCRIPTION OF THE DRAWINGS

FIG. 1 is a cross-sectional view schematically illustrating a gas separation membrane according to an embodiment.

FIG. 2 is a process diagram illustrating a configuration of a method for producing a gas separation membrane according to the embodiment.

FIG. 3 is Table 1 illustrating a configuration of the gas separation membrane and an evaluation result of the gas separation membrane.

FIG. 4 is Table 2 illustrating a configuration of the gas separation membrane and an evaluation result of the gas separation membrane.

FIG. 5 is an example of an XPS spectrum (Si2p) in the vicinity of a Si2p peak.

FIG. 6 is an example of an XPS spectrum (C1s) in the vicinity of a C1s peak.

### DESCRIPTION OF EMBODIMENTS

Hereinafter, a gas separation membrane according to the present disclosure will be described in detail based on an embodiment shown in the accompanying drawings.

### 1. Overview of Gas Separation Membrane

First, a configuration of a gas separation membrane according to an embodiment will be described.

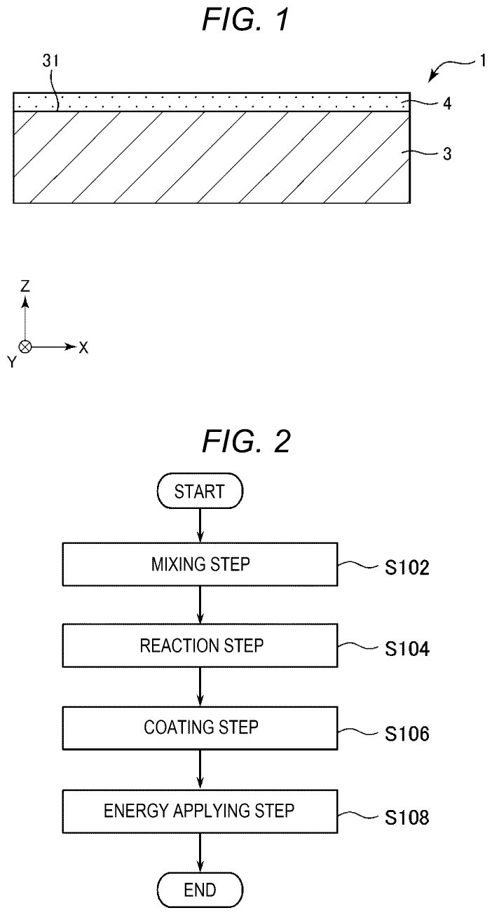

FIG. 1 is a cross-sectional view schematically illustrating a gas separation membrane 1 according to the embodiment. In FIG. 1 of the present application, an X axis, a Y axis, and a Z axis are set as three axes orthogonal to one another, and are indicated by arrows. A base end of the arrow indicating each axis is designated as “minus” and a tip end as “plus”.

In the gas separation membrane 1 illustrated in FIG. 1, a Z axis plus side is referred to as “upper”, and a Z axis minus side is referred to as “lower”. A mixed gas is supplied above the gas separation membrane 1. In the gas separation membrane 1 in FIG. 1, carbon dioxide permeates from an upper side to a lower side and is separated.

The gas separation membrane 1 illustrated in FIG. 1 has a function of permeating and separating carbon dioxide from a mixed gas containing the carbon dioxide. The gas separation membrane 1 illustrated in FIG. 1 includes a sheet-shaped support layer 3 spreading along an X-Y plane, and a separation layer 4 provided on an upper surface 31 (one surface) of the support layer 3. The separation layer 4 has a function of preferentially permeating carbon dioxide, and is formed of a polymer containing a polysiloxane structural unit and a polyethylene oxide structural unit. A film thickness of the separation layer 4 is set to 1 nm or more and 500 nm or less.

Further, when an XPS spectrum of the separation layer 4 is obtained by X-ray photoelectron spectroscopy and a Si2p peak and a C1s peak included in the XPS spectrum are each subjected to waveform separation, an intensity ratio P(Si—O)/P(C—O) of a Si—O peak intensity P(Si—O) to a C—O peak intensity P(C—O) is 0.03 or more and 2.0 or less.

According to such a configuration, the gas separation membrane 1 having high gas selectivity and high gas permeability for carbon dioxide and having excellent mechanical strength can be implemented.

The form of the gas separation membrane according to the present disclosure may be a sheet shape (flat plate shape) illustrated in FIG. 1, a spiral shape, a tubular shape and a hollow fiber shape.

### 1.1. Support Layer

The support layer 3 has a sheet shape and supports the separation layer 4. Accordingly, even when the separation layer 4 does not have sufficient mechanical characteristics, the support layer 3 supports the separation layer 4, thereby implementing the gas separation membrane 1 having excellent mechanical characteristics.

Examples of a constituent material of the support layer 3 include a ceramic material, a metal material, and a polymer material. The constituent material of the support layer 3 may be a composite material of these materials and other materials.

Examples of the ceramic material include alumina, cordierite, mullite, silicon carbide, and zirconia. Examples of the metal material include stainless steel.

Examples of the polymer material include polyolefin-based resins such as polyethylene and polypropylene, fluorine-containing resins such as polytetrafluoroethylene, polyvinyl fluoride, and polyvinylidene fluoride, polystyrene, cellulose acetate, polyurethane, polyacrylonitrile, polyphenylene oxide, polysulfone, polyethersulfone, polyimide, polyaramid, and polysiloxane.

Among them, as the constituent material of the support layer 3, a polymer material is preferably used, and polysulfone or polysiloxane is preferably used. The constituent material of the support layer 3 may be a composite material containing polysulfone or polysiloxane as a main component (more than 50 mass %) in a mass ratio and other resin components in combination.

Polysulfone is a polymer composed of a monomer unit having a —SO₂— bonding group in the molecule.

Among them, in the present embodiment, aromatic-based polysulfone including a repeating unit represented by the following formula (a) or (b) is preferably used. In the following formulae (a) and (b), Ar is an aromatic ring and represents a phenyl group.

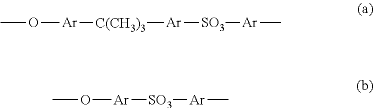

The polysulfone used in the present embodiment may be a modified polysulfone. Examples of the modified polysulfone include those obtained by adding a functional group or an alkyl group to the aromatic ring of the aromatic-based polysulfone represented by the above formula (a) or (b).

Such polysulfone is useful as the constituent material of the support layer 3 because of excellent heat resistance, chemical resistance, and the like.

The polysiloxane includes, as basic structural units, a monofunctional M unit having three organic substituents on a silicon atom, a bifunctional D unit having two organic substituents, a trifunctional T unit having one organic substituent, and a tetrafunctional Q unit having no organic substituent. One molecule of the polysiloxane is formed by combining these units. Among them, the polysiloxane used in the present embodiment is preferably an organopolysiloxane containing almost no Q unit. Thus, the support layer 3 having good gas permeability for carbon dioxide can be obtained.

Specific examples of the organopolysiloxane include polydimethyl siloxane, polymethylphenylsiloxane, polydiphenylsiloxane, polysulfone/polyhydroxystyrene/polydimethylsiloxane copolymer, dimethylsiloxane/methylvinylsiloxane copolymer, dimethylsiloxane/diphenylsiloxane/methylvinylsiloxane copolymer, methyl-3,3,3-trifluoropropylsiloxane/methylvinylsiloxane copolymer, dimethylsiloxane/methylphenylsiloxane/methylvinylsiloxane copolymer, diphenylsiloxane/dimethylsiloxane copolymer terminated with vinyl, a polydimethylsiloxane terminated with vinyl, a polydimethylsiloxane terminated with H, and dimethylsiloxane-methylhydrosiloxane copolymer. This includes a form in which a crosslinking reactant is formed. The constituent material of the support layer 3 may be one kind or a composite of two or more kinds thereof, or may be a composite material containing the organopolysiloxane as a main component (more than 50 mass %) in a mass ratio and other resin components in combination.

The organopolysiloxane has a relatively long interatomic distance of a Si—O bond and a Si—C bond constituting the organopolysiloxane, and has a large free volume, which thus allows good diffusion of carbon dioxide molecules and good gas permeability for carbon dioxide. Therefore, the organopolysiloxane is useful as the constituent material of the support layer 3.

An average thickness of the support layer 3 is preferably set to be larger than an average thickness of the separation layer 4. Accordingly, the support layer 3 serves as a base layer of the gas separation membrane 1 and has necessary and sufficient mechanical characteristics. A difference between the average thickness of the support layer 3 and the average thickness of the separation layer 4 is preferably 5 μm or more, and more preferably 30 μm or more.

An average thickness of the support layer 3 is preferably 10 μm or more and 300 μm or less, more preferably 15 μm or more and 200 μm or less, and still more preferably 20 μm or more and 100 μm or less. Accordingly, the support layer 3 having necessary and sufficient mechanical characteristics and sufficient gas permeability can be implemented.

The average thickness of the support layer 3 is obtained, for example, as an average value of thicknesses measured at 10 locations of the support layer 3 by observing a cross section of the gas separation membrane 1 in an enlarged manner.

The gas permeability of the support layer 3 for carbon dioxide is preferably set higher than the gas permeability of the separation layer 4 for carbon dioxide. Accordingly, the support layer 3 can impart good gas permeability to the gas separation membrane 1 while mechanically supporting the separation layer 4.

The support layer 3 can be produced by a method for producing a sheet or a film. The support layer 3 can also be produced by a method for forming a film on a sacrificial layer and then removing the sacrificial layer.

The support layer 3 may be a porous layer. Thus, the support layer 3 having good gas permeability for carbon dioxide can be obtained.

The porous layer has holes, and an average inner diameter thereof is referred to as an “average hole diameter”. The average hole diameter of the support layer 3 is preferably 0.2 μm or less, more preferably 0.01 μm or more and 0.15 μm or less, still more preferably 0.01 μm or more and 0.09 μm or less, and particularly preferably 0.01 μm or more and 0.07 μm or less. Accordingly, the separation layer 4 can be prevented from slipping out downstream of the support layer 3 while sufficiently ensuring the gas permeability of the support layer 3 for carbon dioxide. When the average hole diameter of the porous layer falls below the above lower limit value, the gas permeability of the support layer 3 for carbon dioxide may decrease. On the other hand, when the average hole diameter of the porous layer exceeds the above upper limit value, the separation layer 4 may slip out downstream of the support layer 3.

The average hole diameter of the porous layer can be measured by a through hole diameter evaluation device after the separation layer 4 is removed from the gas separation membrane 1 and the single support layer 3 is taken out. Examples of the through hole diameter evaluation device include a perm porometer manufactured by PMI.

A porosity of the porous layer is preferably 20% or more and 90% or less, and more preferably 30% or more and 80% or less. Accordingly, the porous layer can achieve both good gas permeability and sufficient rigidity.

The porosity of the porous layer can be measured by the above-described through hole diameter evaluation device after the separation layer 4 is removed from the gas separation membrane 1.

The support layer 3 may be a composite material of the above-described polymer material and fibers. The fiber may be used in the form of a fiber piece such as a chopped strand, but is preferably used in the form of a fabric such as a woven fabric, a non-woven fabric, or a mesh fabric. Thus, the mechanical characteristics of the support layer 3 can be further enhanced.

### 1.2. Separation Layer

The separation layer 4 is provided on the upper surface 31 (one surface) of the support layer 3. The separation layer 4 has gas selectivity for carbon dioxide with respect to nitrogen.

### 1.2.1. Constituent Material

The constituent material of the separation layer 4 is a polymer containing a polyethylene oxide structural unit and a polysiloxane structural unit.

Among them, the polyethylene oxide structural unit is a repeating unit having a —C—C—O— structure in a main chain as described later. Such a structural unit has high affinity for carbon dioxide. Therefore, by providing such a structural unit, the gas selectivity for carbon dioxide in the separation layer 4 can be enhanced. By providing the polyethylene oxide structural unit, the flexibility of the separation layer 4 tends to increase. Therefore, by providing such a structural unit, the adhesion of the separation layer 4 to the support layer 3 can be enhanced, and the durability of the gas separation membrane 1 can be improved.

The polysiloxane structural unit is a repeating unit having a —Si—O— structure in a main chain as described later. Such a structural unit has high gas permeability due to a relatively flexible siloxane bond, a large free volume, and the like. Therefore, the gas permeability for carbon dioxide in the separation layer 4 can be enhanced.

Therefore, by using the above polymer as the constituent material of the separation layer 4, the gas separation membrane 1 having high gas selectivity and high gas permeability for carbon dioxide and excellent mechanical strength can be implemented. Hereinafter, these structural units will be further described.

The polyethylene oxide structural unit is a structural unit represented by the following formula (1).

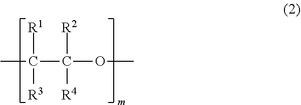

[In the formula (1), R¹, R², R³ and R⁴ each independently represent a hydrogen atom or an alkyl group having 1 to 6 carbon atoms. m is a positive integer.]

Examples of the alkyl group of R¹ to R⁴ in the formula (1) include a methyl group, an ethyl group, an n-propyl group, an isopropyl group, an n-butyl group, an isobutyl group, a t-butyl group, an n-pentyl group, an isopentyl group, an n-hexyl group, and an isohexyl group.

Among them, R¹ to R⁴ are each independently preferably a hydrogen atom or an alkyl group having 1 to 3 carbon atoms.

m in the formula (1) is a positive integer, and is appropriately set such that a molecular weight of the polyethylene oxide structural unit is preferably 100 or more and 500,000 or less, and more preferably 1,000 or more and 100,000 or less.

The molecular weight is a weight-average molecular weight, and is a polystyrene-equivalent molecular weight measured by gel permeation chromatography (GPC method).

The polysiloxane structural unit is a structural unit represented by the following formula (2).

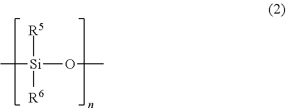

[In the formula (2), R⁵ and R⁶ each independently represent an alkyl group having 1 to 6 carbon atoms. n is a positive integer.]

Examples of the alkyl group of R⁵ and R⁶ in the formula (2) include a methyl group, an ethyl group, an n-propyl group, an isopropyl group, an n-butyl group, an isobutyl group, a t-butyl group, an n-pentyl group, an isopentyl group, an n-hexyl group, and an isohexyl group.

Among them, R⁵ and R⁶ are each independently preferably an alkyl group having 1 to 3 carbon atoms, and more preferably a methyl group.

n in the formula (2) is a positive integer, and is appropriately set such that a molecular weight of the polysiloxane structural unit is preferably 100 or more and 500,000 or less, and more preferably 1,000 or more and 100,000 or less.

The molecular weight is a weight-average molecular weight, and is a polystyrene-equivalent molecular weight measured by gel permeation chromatography (GPC method).

At least one of the two bonds included in the formula (2) is bonded to the polyethylene oxide structural unit. Thus, a polymer chain containing both the polyethylene oxide structural unit and the polysiloxane structural unit is obtained. That is, the polymer chain is formed of a copolymer of the polyethylene oxide structural unit and the polysiloxane structural unit. The copolymer may be a block copolymer or a random copolymer.

The polyethylene oxide structural unit and the polysiloxane structural unit may be directly bonded (bonded by a single bond) or may be bonded via a linking group. Examples of the linking group include an ester bond, an ether bond, an amide bond, an imide bond, a urethane bond, a urea bond, a silyl ether bond, and a carbonyl bond.

The constituent material of the support layer 3 preferably contains the polymer chain as a main component. That is, a total content of the polyethylene oxide structural unit and the polysiloxane structural unit in the constituent material of the support layer 3 is preferably 50 mass % or more, and more preferably 60 mass % or more.

A ratio of a content of the polyethylene oxide structural unit and a content of the polysiloxane structural unit is appropriately set such that the intensity ratio P(Si—O)/P(C—O) in the XPS spectrum described above is within a predetermined range. For example, the intensity ratio P(Si—O)/P(C—O) can be increased by increasing the ratio of the content of the polysiloxane structural unit to the content of the polyethylene oxide structural unit. As an example, the ratio of the content of the polysiloxane structural unit to the content of the polyethylene oxide structural unit is preferably 6/4 or more and 9/1 or less in terms of molar ratio. By setting the ratio of the content within such a range, the separation layer 4 having the intensity ratio P(Si—O)/P(C—O) within the predetermined range can be easily formed.

### 1.2.2. Thickness

An average thickness of the separation layer 4 is 1 nm or more and 500 nm or less, preferably 5 nm or more and 300 nm or less, and more preferably 10 nm or more and 200 nm or less. Accordingly, in the separation layer 4, the gas selectivity for carbon dioxide can be ensured while the gas permeability for carbon dioxide can be increased. When the average thickness of the separation layer 4 falls below the above lower limit value, the gas selectivity for carbon dioxide in the separation layer 4 decreases. On the other hand, when the average thickness of the separation layer 4 exceeds the above upper limit value, the gas permeability for carbon dioxide in the separation layer 4 decreases.

The average thickness of the separation layer 4 is obtained, for example, as an average value of thicknesses measured at 10 locations of the separation layer 4 by observing a cross section of the gas separation membrane 1 in an enlarged manner.

### 1.2.3. Analysis by XPS

The gas separation membrane 1 is subjected to X-ray photoelectron spectroscopy (XPS) in which a surface side of the separation layer 4 is irradiated with X-rays. For the X-ray photoelectron spectroscopy, for example, an X-ray photoelectron spectrometer, PHI X-tool manufactured by ULVAC-PHI, Inc., is used. X-ray irradiation conditions are a beam diameter of 100 μm and an output of 25 W. Analysis conditions are a pass energy of 55 eV and an integration number of 20 or more. MultiPak manufactured by ULVAC-PHI, Inc. is used as the analysis software. The waveform separation processing of the XPS spectrum by the analysis software is performed as follows.

First, the acquired XPS spectrum is loaded into analysis software, and the peak position is corrected. As a reference peak of the correction, a C—C peak included in the C1s peak is used, and a peak top is corrected to be 284.8 eV.

Next, for the Si2p peak present at 102.5 eV±3.0 eV, waveform separation is performed using a Gaussian function as a fitting function. By the waveform separation, a Si—O peak is separated as a main peak. An intensity of the separated Si—O peak is recorded as “intensity P(Si—O)”. The Si—O peak is generally located around 102.5 eV.

Next, for the C1s peak present at 282 eV to 290 eV, the waveform separation is performed using a Gaussian function as a fitting function. By the waveform separation, a C—O peak and a C—C peak are separated as main peaks. An intensity of the separated C—O peak is recorded as “intensity P(C—O)”. The C—O peak is generally located around 286.3 eV, and the C—C peak is generally located around 284.8 eV.

Next, a ratio of the intensity P(Si—O) to the intensity P(C—O) is calculated as “intensity ratio P(Si—O)/P(C—O)”.

In the separation layer 4, the intensity ratio P(Si—O)/P(C—O) is 0.03 or more and 2.0 or less. A C—O bond, which is an origin of the intensity P(C—O), affects the gas selectivity of the separation layer 4 for carbon dioxide and the adhesion of the separation layer 4 to the support layer 3. A Si—O bond, which is an origin of the intensity P(Si—O), affects the gas permeability for carbon dioxide. When the intensity ratio P(Si—O)/P(C—O) is within the above range, a balance between the gas selectivity derived from the C—O bond and the adhesion to the support layer 3 and the gas permeability derived from the Si—O bond can be optimized, and the gas separation membrane 1 satisfying these characteristics can be implemented.

When the intensity ratio P(Si—O)/P(C—O) falls below the above lower limit value, a relative amount of the Si—O bond decreases, and thus the gas permeability of the gas separation membrane 1 for carbon dioxide decreases. On the other hand, when the intensity ratio P(Si—O)/P(C—O) exceeds the above upper limit value, a relative amount of the C—O bond decreases, and thus the gas selectivity of the gas separation membrane 1 for carbon dioxide decreases or the adhesion of the separation layer 4 to the support layer 3 decreases.

### 1.3. Another Configuration

Although the gas separation membrane 1 according to the embodiment is described above, any layer may be provided downstream of the support layer 3. For example, a porous plate having rigidity higher than that of the support layer 3 may be provided downstream of the support layer 3. The porous plate is formed with a large number of through holes such that a pressure loss of gas passing therethrough is smaller than that of the support layer 3. Accordingly, the gas separation membrane 1 can be supported without inhibiting the gas selectivity of the gas separation membrane 1 for carbon dioxide. Examples of the constituent material of the porous plate include a ceramic material, a metal material and a polymer material.

### 1.4. Characteristics of Gas Separation Membrane

Gas permeability R_{CO2} of the gas separation membrane 1 for carbon dioxide is preferably 500×10⁻⁶ cm³ (STP)/cm²·sec·cmHg or more (500 GPU or more), more preferably 5,000 GPU or more and 1,000,000 GPU or less, and still more preferably 10,000 GPU or more and 800,000 GPU or less. Accordingly, the gas separation membrane 1 having high carbon dioxide separation efficiency can be obtained. The gas separation membrane 1 that can reduce an input amount of energy required for separation, specifically, that can reduce a difference between pressures upstream and downstream of the gas separation membrane 1 can be implemented. The gas permeability R_{CO2} for carbon dioxide can be measured by a method to be described later.

The gas permeability of the gas separation membrane 1 for nitrogen is represented by R_{N2}, and the gas permeability for carbon dioxide is represented by R_{CO2}. At this time, a gas selectivity ratio R_{CO2}/R_{N2} of the gas separation membrane 1 is preferably 15 or more, and more preferably 20 or more. When the gas selectivity ratio R_{CO2}/R_{N2} is within the above range, the gas separation membrane 1 can efficiently separate and collect carbon dioxide in a mixed gas. On the other hand, the upper limit value of the gas selectivity ratio R_{CO2}/R_{N2} may not be set, and is preferably 100 or less from the viewpoint of enhancing the ease of production of the gas separation membrane 1.

### 2. Method for Producing Gas Separation Membrane

Next, a method for producing a gas separation membrane according to the embodiment will be described. In the following description, a method for producing the gas separation membrane 1 illustrated in FIG. 1 will be described as an example.

FIG. 2 is a process diagram illustrating a configuration of the method for producing a gas separation membrane according to the embodiment.

The method for producing a gas separation membrane illustrated in FIG. 2 includes a mixing step S102, a reaction step S104, a coating step S106, and an energy applying step S108. According to such a configuration, the gas separation membrane 1 having high gas selectivity and high gas permeability for carbon dioxide and excellent mechanical strength can be efficiently produced. Hereinafter, each step will be described.

### 2.1. Mixing Step

In the mixing step S102, a polyethylene glycol compound and a polysiloxane compound are mixed to prepare a mixture.

The polyethylene glycol compound is represented by the following formula (3).

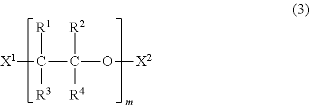

[In the formula (3), R¹, R², R³ and R⁴ each independently represent a hydrogen atom or an alkyl group having 1 to 6 carbon atoms. X¹ and X² are first reactive functional groups which may be the same as or different from each other. m is a positive integer.]

The alkyl group of R¹ to R⁴ in the above formula (3) is the same as the alkyl group of R¹ to R⁴ in the above formula (1).

X¹ and X² are the first reactive functional groups that are located at ends of a main chain of the formula (3), have reactivity with the second reactive functional group to be described later, and can be bonded to the second reactive functional group. X¹ and X² may be the same first reactive functional group as each other or may be different first reactive functional groups from each other.

Examples of the first reactive functional group include a hydroxy group, a carboxy group, a vinyl group, an acrylic group, an isocyanate group, a mercapto group, an isothiocyanate group, an epoxy group, an aziridine group, an azlactone group, a maleimide group, an amino group, a thiol group, an azide group, a chloro-s-triazine group, and a β-chloroethylaminosulfonyl group, and one type or two or more types thereof are used in combination. Among them, one or more selected from the group consisting of a hydroxy group, a carboxy group, a vinyl group, an acrylic group, an isocyanate group, and a mercapto group are preferably used as the first reactive functional group. By using these functional groups in the polyethylene glycol compound, the reactivity of the first reactive functional group can be further increased, and thus the separation layer 4 having excellent coatability can be efficiently formed.

The polysiloxane compound is represented by the following formula (4).

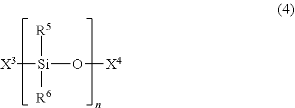

The alkyl group of R⁵ and R⁶ in the above formula (4) is the same as the alkyl group of R⁵ and R⁶ in the above formula (2).

X³ and X⁴ are the second reactive functional groups that are located at ends of a main chain of the formula (4), have reactivity with the first reactive functional group, and can be bonded to the first reactive functional group. X³ and X⁴ may be the same second reactive functional group as each other or may be different second reactive functional groups from each other.

The second reactive functional group is not particularly limited as long as it is a functional group capable of being reactive with and bondable to the first reactive functional group, and is appropriately selected from, for example, those exemplified as the first reactive functional group described above. Among them, one or more selected from the group consisting of a hydroxy group, a carboxy group, a vinyl group, an acrylic group, an isocyanate group, and a mercapto group are preferably used as the second reactive functional group. By using these functional groups in the polyethylene glycol compound, the reactivity of the second reactive functional group can be further increased, and thus the separation layer 4 having excellent coatability can be efficiently formed.

As the polysiloxane compound represented by the formula (4), a polydimethylsiloxane having second reactive functional groups at both ends of a main chain is particularly preferably used. The polydimethylsiloxane has particularly good gas permeability for carbon dioxide and excellent weather resistance due to an increase in molecular spacing caused by the presence of a Si—CH₃ bond. Therefore, the polydimethylsiloxane is useful as the polysiloxane compound used for forming the separation layer 4.

A mixing ratio of the polyethylene glycol compound and the polysiloxane compound in the mixture is appropriately set according to the target intensity ratio P(Si—O)/P(C—O).

A solvent that dissolves these compounds may be used in the mixture. The solvent is not limited as long as it does not inhibit the reaction, and examples thereof include hydrocarbon-based solvents such as hexane and heptane; aromatic-based hydrocarbon solvents such as benzene, toluene and xylene; ether-based solvents such as diethyl ether, tetrahydrofuran and dioxane; halogenated hydrocarbon-based solvents such as methylene chloride and carbon tetrachloride; and ester-based solvents such as ethyl acetate. These solvents may be used alone or in combination.

### 2.2. Reaction Step

In the reaction step S104, the mixture is heated to react the first reactive functional group with the second reactive functional group. Thus, a reactant is obtained.

A heating temperature of the mixture is not particularly limited, and is preferably 40° C. or higher and 250° C. or lower, and more preferably 50° C. or higher and 100° C. or lower. Accordingly, the first reactive functional group and the second reactive functional group can be reacted efficiently while preventing an unintended side reaction, evaporation of raw materials, and the like.

At the time of heating, the mixture may be subjected to a stirring treatment, an ultrasonic irradiation treatment, or the like as necessary.

### 2.3. Coating Step

In the coating step S106, the prepared reactant is applied to the upper surface 31 (one surface) of the support layer 3. Thus, a coating film is formed.

The coating method is not particularly limited, and examples thereof include a dipping method, a dripping method, an inkjet method, a dispenser method, a spraying method, a screen printing method, a coater coating method, and a spin coating method.

Prior to the application of the reactant, the upper surface 31 of the support layer 3 may be subjected to an activation treatment. The activation treatment is not particularly limited as long as it is processing of activating the upper surface 31. Examples of the activation treatment include a method of irradiating the upper surface 31 with energy rays, a method of heating the upper surface 31, a method of exposing the upper surface 31 to plasma or corona, and a method of exposing the upper surface 31 to an ozone gas. Examples of the energy ray include infrared rays, ultraviolet rays, and visible light.

After the coating film is formed, the coating film is dried as necessary. The drying method is not particularly limited, and may be natural drying or forced drying.

### 2.4. Energy Applying Step

In the energy applying step S108, energy is applied to the coating film. This causes a polymerization reaction.

The method of applying energy is not particularly limited, and examples thereof include a method of irradiating with light and a method of irradiating with plasma. Among them, a method of irradiating with plasma is preferably used. By using the plasma, the polymerization reaction can be efficiently proceeded while preventing an increase in temperature. Accordingly, the separation layer 4 can be formed in a shorter time while preventing deterioration of the support layer 3 due to heat.

The energy is preferably applied from a front surface side of the coating film. Accordingly, the polymerization reaction preferentially proceeds on the front surface side of the coating film, and the film formation proceeds. On the other hand, on a back surface side of the coating film, the polymerization reaction does not proceed or proceeds later than on the front surface side. Therefore, the application of energy may be stopped when the film formation has progressed to some extent. In this case, unreacted materials remain, but the unreacted materials can be removed by washing from the back surface side. For the washing, a solvent capable of dissolving unreacted materials is used. By such a method, the film thickness of the separation layer 4 can be controlled more accurately.

The method of generating plasma is not particularly limited, and an atmospheric pressure plasma device is preferably used. The method of irradiating with plasma is not particularly limited, and by using a method of transferring plasma generated at a plasma generation site and irradiating with the plasma (plasma jet method), deterioration of an object to be processed due to discharge or the like can be prevented.

### 3. Use of Gas Separation Membrane

The gas separation membrane 1 according to the embodiment can be used for carbon dioxide separation and collection from a mixed gas containing carbon dioxide, carbon dioxide separation and purification, and the like. In particular, it is effective to use the gas separation membrane 1 in a technique for separating and collecting carbon dioxide contained in the atmosphere (direct air recovery (DAC)).

### 4. Effects of Embodiment

As described above, the gas separation membrane 1 according to the embodiment is a gas separation membrane that permeates and separates carbon dioxide from a mixed gas containing the carbon dioxide. Such a gas separation membrane 1 includes the support layer 3 having a sheet shape and the separation layer 4 provided on the upper surface 31 (one surface) of the support layer 3. The separation layer 4 has a function of selecting and separating carbon dioxide, and is formed of a polymer containing a polyethylene oxide structural unit and a polysiloxane structural unit. An average thickness of the separation layer 4 is 1 nm or more and 500 nm or less. When an XPS spectrum of the separation layer 4 is obtained by X-ray photoelectron spectroscopy and a Si2p peak and a C1s peak included in the XPS spectrum are each subjected to waveform separation, an intensity ratio P(Si—O)/P(C—O) of a Si—O peak intensity P(Si—O) to a C—O peak intensity P(C—O) is 0.03 or more and 2.0 or less.

According to such a configuration, the gas separation membrane 1 having high gas selectivity and high gas permeability for carbon dioxide and excellent mechanical strength can be implemented.

In the gas separation membrane 1 according to the embodiment, a ratio of a content of the polysiloxane structural unit to a content of the polyethylene oxide structural unit is preferably 6/4 or more and 9/1 or less in terms of molar ratio.

According to such a configuration, the separation layer 4 having an intensity ratio P(Si—O)/P(C—O) within a predetermined range can be easily formed.

In the gas separation membrane 1 according to the embodiment, it is preferable that a gas selectivity ratio R_{CO2}/R_{N2} is 15 or more, where R_{N2} is gas permeability for nitrogen and R_{CO2} is gas permeability for carbon dioxide, and the gas permeability for carbon dioxide R_{CO2} is 500 GPU or more.

According to such a configuration, the gas separation membrane 1 capable of efficiently separating and collecting carbon dioxide in the mixed gas can be implemented.

The method for producing a gas separation membrane according to the embodiment is a method for producing the gas separation membrane 1 according to the embodiment and includes the mixing step S102, the reaction step S104, the coating step S106, and the energy applying step S108. In the mixing step S102, a polyethylene glycol compound having a first reactive functional group at an end of a main chain and a polysiloxane compound having a second reactive functional group at an end of a main chain, the second reactive functional group being reactive with and bondable to the first reactive functional group, are mixed to obtain a mixture. In the reaction step S104, the mixture is heated to react the first reactive functional group with the second reactive functional group to obtain a reactant. In the coating step S106, the reactant is applied to the upper surface 31 (one surface) of the support layer 3 to form a coating film. In the energy applying step S108, energy is applied to the coating film to form the separation layer 4.

According to such a configuration, the gas separation membrane 1 having high gas selectivity and high gas permeability for carbon dioxide and excellent mechanical strength can be efficiently produced.

In the method for producing a gas separation membrane according to the embodiment, at least one of the first reactive functional group and the second reactive functional group may be selected from the group consisting of a hydroxy group, a carboxy group, a vinyl group, an acrylic group, an isocyanate group, and a mercapto group.

According to such a configuration, since the reactivity of the first reactive functional group and the second reactive functional group can be further enhanced, the separation layer 4 having excellent coatability can be efficiently formed.

In the method for producing a gas separation membrane according to the embodiment, the polysiloxane compound may be a polydimethylsiloxane having a second reactive functional group at an end of a main chain.

According to such a configuration, due to the influence of an increase in molecular spacing in a polydimethylsiloxane, the separation layer 4 having particularly good gas permeability for carbon dioxide and excellent weather resistance can be implemented.

Although the gas separation membrane and the method for producing a gas separation membrane according to the present disclosure have been described above based on the preferred embodiment, the present disclosure is not limited thereto.

For example, in the gas separation membrane according to the present disclosure, each part of the embodiment described above may be replaced with a component having a similar function, or any component may be added to the embodiment described above.

The method for producing a gas separation membrane according to the present disclosure may be one in which any desired process is added to the above embodiment.

### EXAMPLE

Next, specific examples of the present disclosure will be described.

### 5. Preparation of Gas Separation Membrane

### 5.1. Example 1

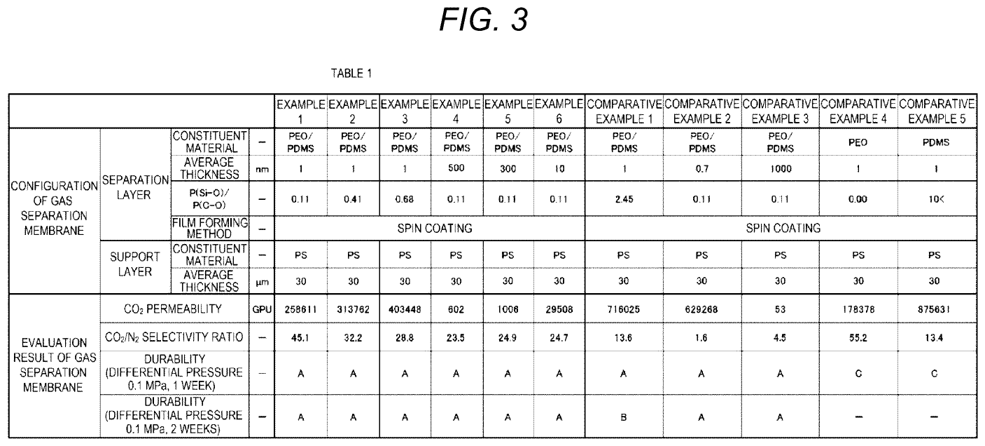

First, a PS sheet is prepared as a support layer. The PS sheet is a porous sheet whose constituent material is polysulfone (PS) and has an average thickness illustrated in Table 1 (FIG. 3). Next, one surface of the PS sheet was subjected to a corona treatment as an activation treatment.

Next, polyethylene glycol and a polydimethylsiloxane were mixed to prepare a mixture. Next, the prepared mixture was heated at 80° C. for 30 minutes while being stirred with a stirrer to obtain a reactant. Regarding a mixing ratio of the polyethylene glycol and the polydimethylsiloxane, a ratio of a content of a polysiloxane structural unit to a content of a polyethylene oxide structural unit was in a range of 6/4 or more and 9/1 or less in terms of molar ratio.

Next, the reactant was applied to one surface of the PS sheet to obtain a coating film. Spin coating was used as the coating method. Thereafter, the coating film was dried.

Next, the coating film was subjected to plasma irradiation. An atmospheric pressure plasma device was used for the plasma irradiation. Thus, the raw material was formed into a film. Then, a separation layer composed of a polymer containing a polyethylene oxide structural unit (PEO) and a polysiloxane structural unit (PDMS) was formed to obtain a gas separation membrane.

Next, the obtained gas separation membrane was immersed in an organic solvent. Thus, unreacted materials were removed.

### 5.2. Examples 2 to 13 and Comparative Examples 1 to 3

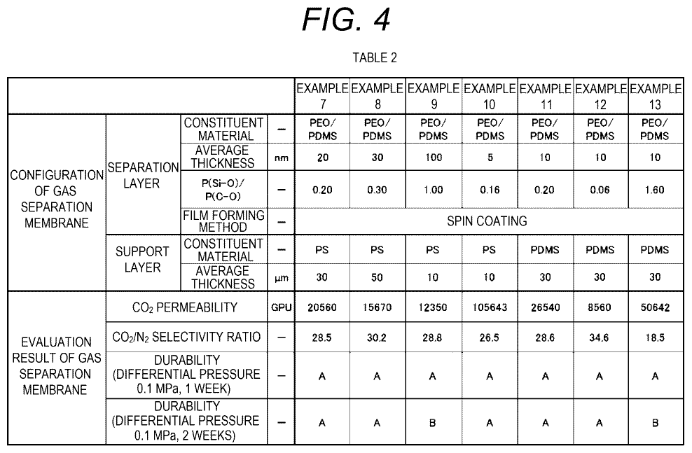

Gas separation membranes were obtained in the same manner as in Example 1 except that configurations of the gas separation membranes were changed as shown in Table 1 (FIG. 3) or Table 2 (FIG. 4). “PDMS” as a constituent material of the support layer refers to a polydimethylsiloxane sheet.

### 5.3. Comparative Example 4

A gas separation membrane was obtained in the same manner as in Example 1 except that a constituent material of a separation layer was composed of only a polyethylene oxide structural unit (PEO) and other configurations were as shown in Table 1.

### 5.4. Comparative Example 5

A gas separation membrane was obtained in the same manner as in Example 1 except that a constituent material of a separation layer was composed of only a polysiloxane structural unit (PDMS) and other configurations were as shown in Table 1.

FIG. 3 is Table 1 illustrating a configuration of the gas separation membrane and an evaluation result of the gas separation membrane. FIG. 4 is Table 2 illustrating a configuration of the gas separation membrane and an evaluation result of the gas separation membrane.

### 6. X-Ray Photoelectron Spectroscopy Analysis for Gas Separation Membrane

The gas separation membranes in Examples and Comparative Examples were subjected to X-ray photoelectron spectroscopy analysis. The XPS spectrum was subjected to waveform separation processing using analysis software to obtain an intensity P(C—O) and an intensity P(Si—O). An intensity ratio P(Si—O)/P(C—O) was calculated. The calculated intensity ratio P(Si—O)/P(C—O) is shown in Table 1 and Table 2.

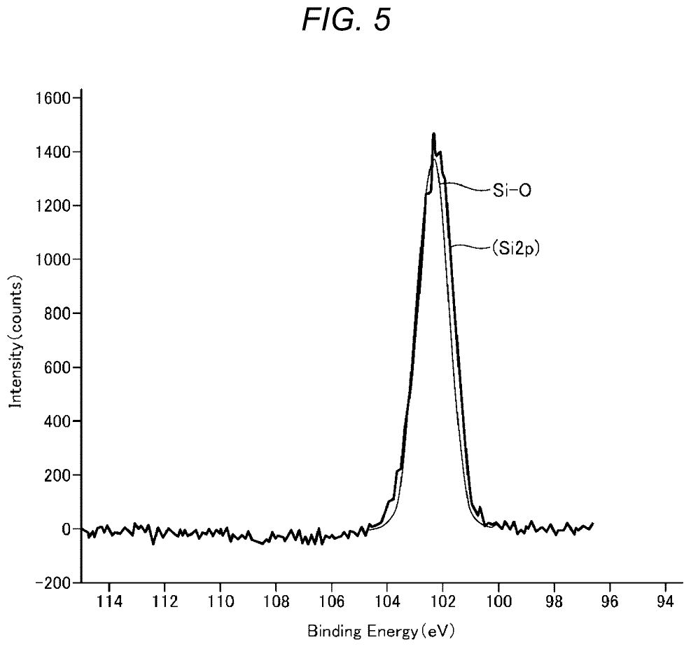

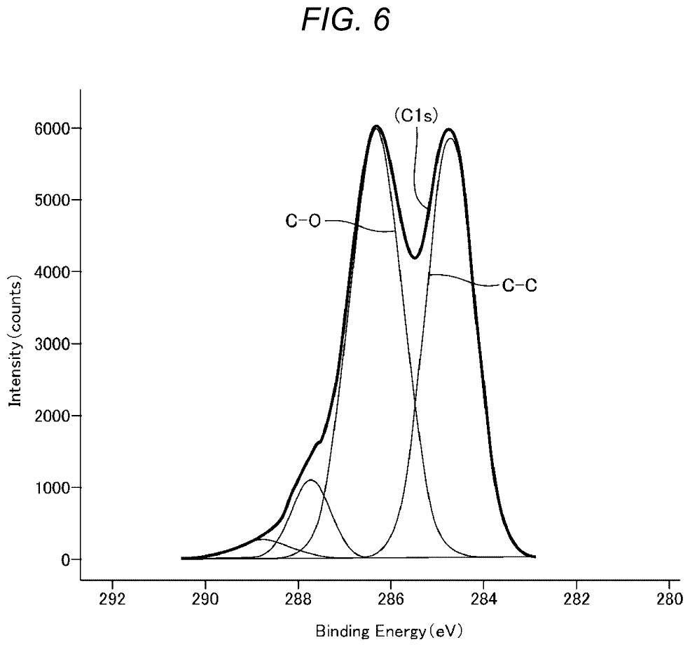

FIG. 5 is an example of an XPS spectrum (Si2p) in the vicinity of a Si2p peak. FIG. 6 is an example of an XPS spectrum (C1s) in the vicinity of a C1s peak. FIG. 6 illustrates a C—C peak and a C—O peak separated by the waveform separation processing.

### 7. Evaluation of Gas Separation Membrane

The gas separation membranes in Examples and Comparative Examples were evaluated as follows.

### 7.1. Gas Permeability (CO₂ Permeability)

The gas separation membranes in Examples and Comparative Examples were cut into a circle having a diameter of 5 cm to prepare test samples. Next, using a gas permeability measuring device, a mixed gas obtained by mixing carbon dioxide:nitrogen at a volume ratio of 13:87 was supplied upstream of the test sample. At this time, a total upstream pressure was adjusted to 5 MPa, a partial pressure of carbon dioxide was adjusted to 0.65 MPa, a flow rate of the mixed gas was adjusted to 500 mL/min, and a temperature was adjusted to 40° C. The gas permeability was measured according to a gas permeability test method (Part 1: differential pressure method) specified in JIS K 7126-1:2006. As the gas permeability measuring device, GTR-11A/31A manufactured by GTR TEC Corporation was used. In the device, gas permeating the test sample is introduced into a gas chromatograph, and the gas permeability of each component is measured.

Next, the CO₂ permeability in each gas separation membrane was calculated based on the analysis result. The calculation results are shown in Table 1 and Table 2.

### 7.2. Gas Selectivity (CO₂/N₂ Selectivity Ratio)

Based on the above-described analysis results, the N₂ permeability in the gas separation membrane was calculated. Subsequently, a ratio of the CO₂ gas permeability to the N₂ gas permeability was calculated as a CO₂/N₂ gas selectivity ratio. The calculation results are shown in Table 1 and Table 2.

### 7.3. Durability

The gas separation membranes in Examples and Comparative Examples were set in a gas permeability measuring device, and the downstream pressure was depressurized such that a difference between pressures upstream and downstream (differential pressure) was 0.1 MPa. Then, this state was maintained for one week.

After one week, the gas separation membranes were taken out and observed under magnification to check for any damage. Then, calculation results were evaluated in view of the following evaluation criteria. The evaluation results are shown in Tables 1 and 2.
A: No damage was observed in the gas separation membrane.
C: Damage was observed in the gas separation membrane.

Next, the gas separation membrane subjected to the magnified observation was set in the gas permeability measuring device again, and was held for one week by applying a pressure difference in the same manner as described above.

After one week, the gas separation membranes were taken out and observed under magnification to check for any damage. Then, observation results were evaluated in view of the following evaluation criteria. The evaluation results are shown in Tables 1 and 2.
A: No damage was observed in the gas separation membrane.
B: Damage was observed in the gas separation membrane.

As is clear from Table 1 and Table 2, it was confirmed that the gas separation membranes in Examples had high gas selectivity and high gas permeability for carbon dioxide and had excellent mechanical strength.

What is claimed is:

1. A gas separation membrane for permeating and separating carbon dioxide from a mixed gas containing the carbon dioxide, the gas separation membrane comprising:
a sheet-shaped support layer; and
a separation layer provided on one surface of the support layer, the separation layer having a function of selecting and separating carbon dioxide and being formed of a polymer containing a polyethylene oxide structural unit and a polysiloxane structural unit, wherein
the separation layer has an average thickness of 1 nm or more and 500 nm or less, and
when an XPS spectrum of the separation layer is obtained by X-ray photoelectron spectroscopy and a Si2p peak and a C1s peak included in the XPS spectrum are each subjected to waveform separation, an intensity ratio P(Si—O)/P(C—O) of a Si—O peak intensity P(Si—O) to a C—O peak intensity P(C—O) is 0.03 or more and 2.0 or less.

2. The gas separation membrane according to claim 1, wherein
a ratio of a content of the polysiloxane structural unit to a content of the polyethylene oxide structural unit is 6/4 or more and 9/1 or less in terms of molar ratio.

3. The gas separation membrane according to claim 1, wherein
a gas selectivity ratio R_{CO2}/R_{N2} is 15 or more, where R_{N2} is gas permeability for nitrogen and R_{CO2} is gas permeability for carbon dioxide, and
the gas permeability for carbon dioxide R_{CO2} is 500 GPU or more.

4. A method for producing a gas separation membrane, which is a method for producing the gas separation membrane according to claim 1, the method comprising:
mixing a polyethylene glycol compound having a first reactive functional group at an end of a main chain and a polysiloxane compound having a second reactive functional group at an end of a main chain, the second reactive functional group being reactive with and bondable to the first reactive functional group, to obtain a mixture;
heating the mixture to react the first reactive functional group with the second reactive functional group to obtain a reactant;
applying the reactant to one surface of the support layer to form a coating film; and
applying energy to the coating film to form the separation layer.

5. The method for producing a gas separation membrane according to claim 4, wherein
at least one of the first reactive functional group and the second reactive functional group is selected from the group consisting of a hydroxy group, a carboxy group, a vinyl group, an acrylic group, an isocyanate group, and a mercapto group.

6. The method for producing a gas separation membrane according to claim 4, wherein
the polysiloxane compound is a polydimethylsiloxane having the second reactive functional group at an end of a main chain.
